(19) United States
(12) Patent Application Publication
(10) Pub. No.: US 2021/0324666 A1
(43) Pub. Date: Oct. 21, 2021

(54) CONTAINER WITH LATCH ASSEMBLY

(71) Applicant: ORBIS Corporation, Oconomowoc, WI (US)

(72) Inventor: Taylor James Bahr, Jefferson, WI (US)

(21) Appl. No.: 17/224,689

(22) Filed: Apr. 7, 2021

Related U.S. Application Data
(60) Provisional application No. 63/013,065, filed on Apr. 21, 2020.

(51) Int. Cl. E05C 1/10; E05C 1/00; B65D 45/18

(52) U.S. Cl. CPC E05C 1/10; B65D 45/18; E05C 1/004

(57) ABSTRACT

The invention is directed to a latch assembly for use with a top cap for connecting the top cap to a container body. The latch assembly includes a latch having a latch body with a planar portion and an arcuate portion. A snap hook and a pull tab is connected to an end of the arcuate portion. The latch also includes a clasping portion for securing it to a ramp on the top cap and a spring element.

### CROSS-REFERENCE TO RELATED APPLICATIONS

The present invention claims priority to and the benefit of U.S. Provisional Patent Application No. 63/013,065 filed Apr. 21, 2020, the contents of which are incorporated herein by reference and made a part hereof.

### FEDERALLY SPONSORED RESEARCH OR DEVELOPMENT

N/A

### FIELD OF THE INVENTION

The present invention generally relates to a container having a latch assembly in a top cap for securing the top cap to a container body, and to a latch assembly having a latch body, a spring element, a clasping portion for securing the latch assembly to the top cap and a snap hook for contacting the container body.

### DESCRIPTION OF THE PRIOR ART

A number of different latch configurations are used with containers. Some latches are used to prevent a rotatable door or side wall from moving. Others can be used to secure a top cap to a container. In one known top cap, the latch is integrally formed or molded as a feature of the top cap.

The present latch can be connected to a top cap and utilizes a spring element to enable the top cap to be securely attached to a container body. Other features of the latch are discussed and shown herein.

### SUMMARY OF THE INVENTION

The present invention is directed to a container with a latch assembly for connecting a top cap to a tote or container body. The latch can be formed from plastic or other similar or suitable materials.

In accordance with one aspect of the invention, a latch for connecting a top cap to a container body is provided. The latch comprises a latch body, a spring connected to the latch body and extending outward past a first end of the latch body, and a snap hook connected to the latch body and extending outward from a second end of the latch body.

The latch body can include a first planar portion and a second arcuate portion. The snap hook can extend inward from an end of the arcuate portion.

A pull tab can also extend from the arcuate portion. The pull tab can include a vertical wall extending upward from a bottom portion of the arcuate portion.

A clasp portion can extend downward from the first planar portion of the latch body. The clasp portion can include a vertical wall connected at one end to a lower portion of the first planar portion. The vertical wall can extend downward from a mid-portion of the planar portion of the latch body. The clasp portion can also include a horizontal wall extending at a first end from a second end of the vertical wall. The horizontal wall can be parallel to the lower portion of the latch body.

The spring can be connected to a second end of the horizontal wall of the clasp portion. The spring can include a first leaf spring component and a second leaf spring component.

In accordance with another aspect of the invention, a latch assembly in a top cap for connecting the top cap to a container body is provided. The latch assembly comprises a top cap having a first side, a second side, a first end and a second end and a first slot extending inward from the first end. A first ramp extends from a bottom surface of the top cap connected proximate an interior end of the first slot and a first latch having a clasp is connected to the first ramp. The latch includes a latch body, a spring and a snap hook configured to cooperate with a groove in the container body.

The latch body can include a planar portion and an arcuate portion. The spring in the latch can include a first leaf spring element and a second leaf spring element. The latch can also include a pull tab.

The ramp can include a vertical wall extending downward from the top cap. The first spring element and the second spring element can be supported against the vertical wall of the ramp.

Other features and advantages of the invention will be apparent from the following specification taken in conjunction with the following Figures.

### BRIEF DESCRIPTION OF THE DRAWINGS

To understand the present invention, it will now be described by way of example, with reference to the accompanying drawings in which:

FIG. 1 is a perspective view of the container with latch assembly in accordance with an aspect of the present invention;

FIG. 2 is a top perspective view of a top cap and the latch assembly of the container of FIG. 1;

FIG. 3 is a bottom perspective view of the top cap and latch assembly of FIG. 2;

FIG. 4 is a top perspective view of the top cap of FIG. 2 without the latch assembly;

FIG. 5 is a bottom perspective view of the top cap of FIG. 2 without the latch assembly;

FIG. 6 is a top perspective view of the latch assembly of FIG. 1;

FIG. 7 is a lower perspective view of the latch assembly of FIG. 1;

FIG. 8 is a cross-sectional view of the container and latch assembly of FIG. 1 illustrating the channel in the latch on the top cap;

FIG. 9 is a cross-sectional view of the container and latch assembly of FIG. 1 illustrating the snap hook of the latch assembly in a groove in the container body;

FIG. 10 is an elevated perspective view of the bottom of the top cap of the container of FIG. 1 illustrating aspects of the ramp for connection with the latch assembly;

FIG. 11 is a perspective view of an alternative latch assembly in a top cap;

FIG. 12 is a cross-sectional view of the alternative latch with the container body and top cap;

FIG. 13 is an elevated enlarged perspective view of the latch assembly and top cap; and,

FIG. 14 is a lower enlarged perspective view of the latch assembly and top cap.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

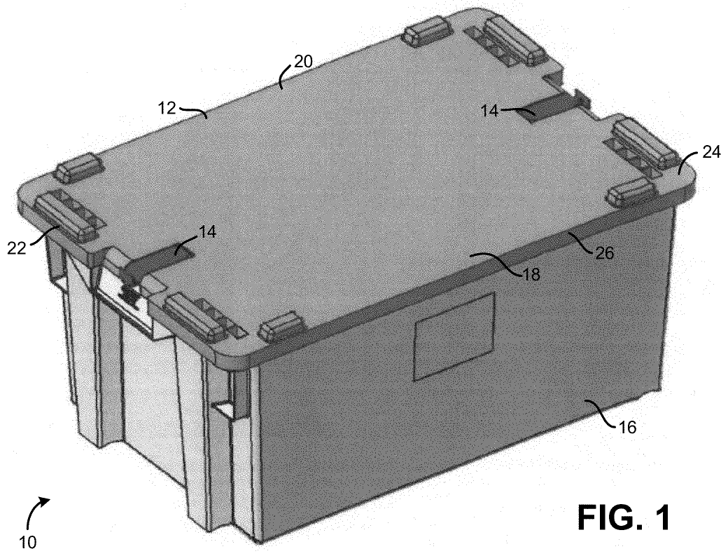

FIG. 1 shows a container 10 with a latch assembly in accordance with the present invention. The container 10 (sometimes referred to as a tote) includes a top cap or lid 12 and two latches 14 secured to the ends of the top cap 12. The top cap 12 is positioned on a container body 16. The latches 14 secure the top cap 12 to the container body 16.

The top cap 12 is generally rectangular having a first side 18, a second side 20, a first end 22 and a second end 24. A lip 26 extends downward about the periphery of the top cap 12.

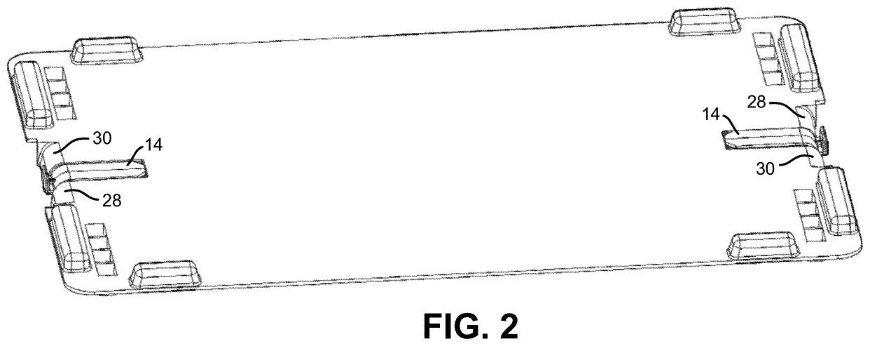

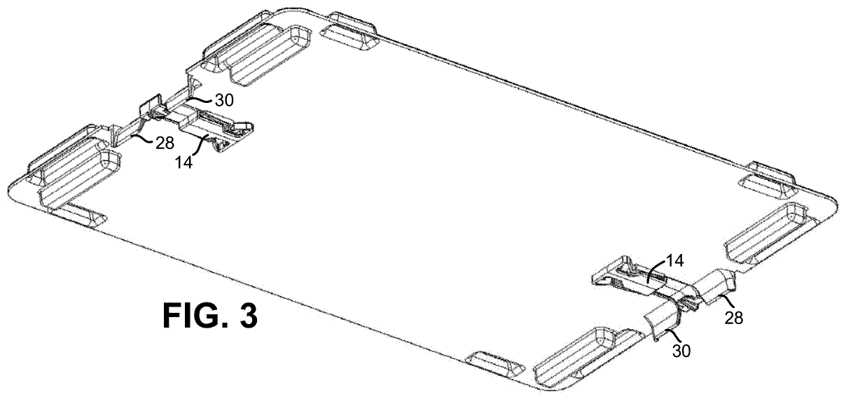

FIGS. 2 and 3 show the top and the bottom of the top cap 12 with the latches 14 in place. As illustrated, each latch 14 is located in a mid-portion of the respective ends 22, 24 between the two sides 18, 20. At each end 22, 24, the top cap 12 includes a first arcuate portion 28 on one side of each latch 14 and a second arcuate portion 30 on the other side of the latch 14. As described in more detail below, the latches 14 conform to the arcuate shapes 28, 30 at the ends 22, 24 of the top cap 12.

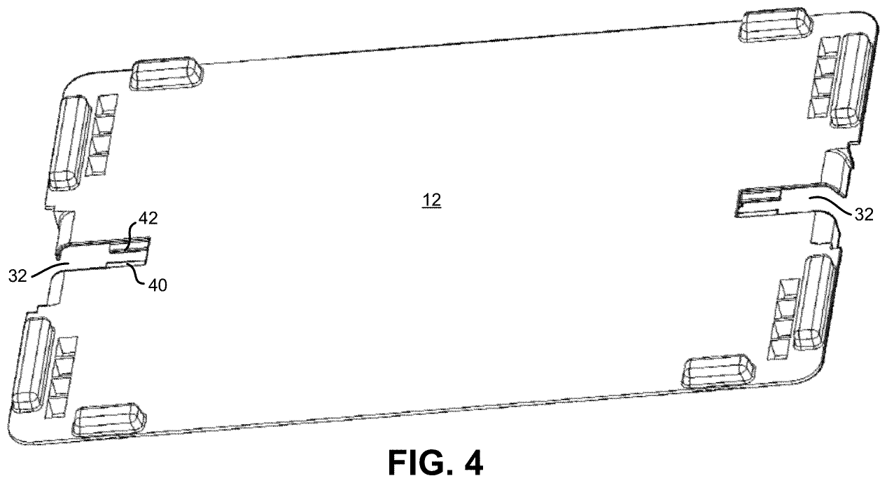

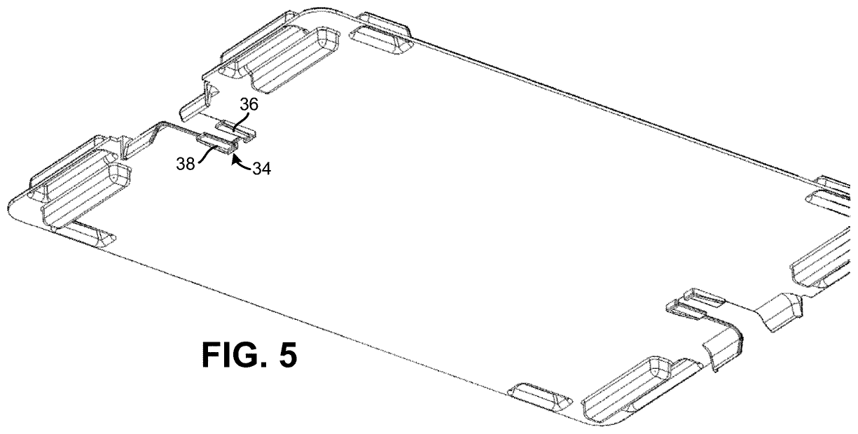

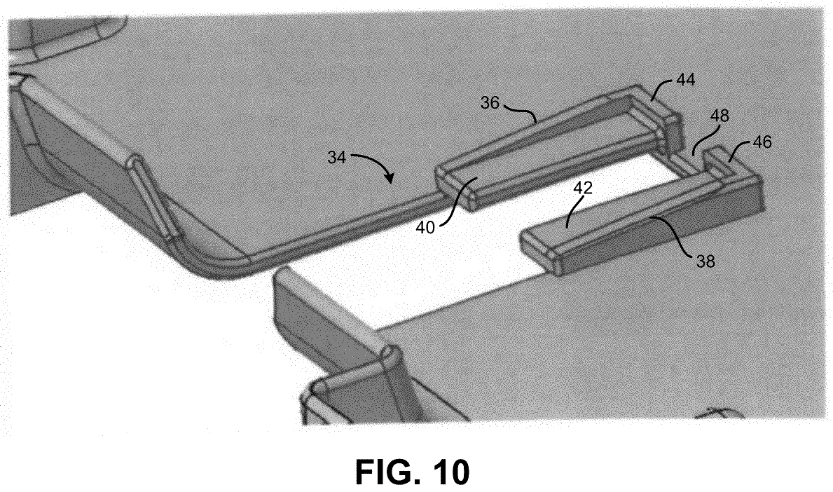

FIGS. 4 and 5 show the top cap 12 with the latches 14 removed. As apparent, each latch 14 fits in a slot 32 formed in the top cap 12 at each end 22, 24. A ramp 34 (also shown enlarged in FIG. 10) having a first portion 36 and a second portion 38 is shown extending downward from the top cap 12 proximate an interior end of each slot 32. The first portion 36 of the ramp 34 includes a planar segment 40 extending outward into the area beneath the slot 32 on one side and the second portion 38 includes a planar segment 42 extending outward into the area beneath the slot 32 on the other side. Each of the first portion 36 and second portion 38 includes a vertical wall 44, 46 at the extreme interior end of each slot 32 with a gap 48 between the walls 44, 46. As described herein, the latch 14 includes structure which cooperates with the structure of the ramp 34 to secure the latch 14 to the top cap 12 and enable it to function in a manner to secure the top cap 12 to the container body 16.

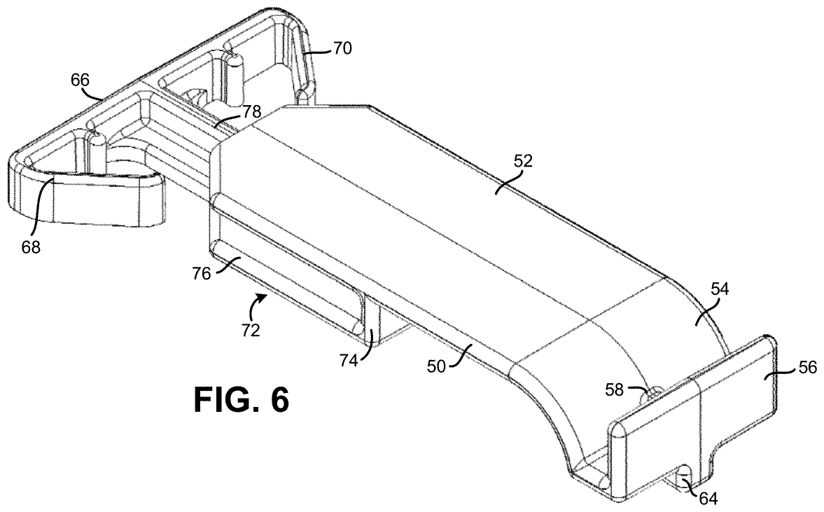

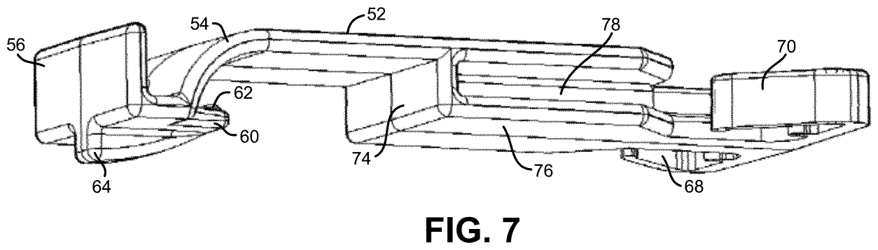

The latch 14 is shown on its own in FIGS. 6 and 7. The latch 14 includes a latch body 50 having a generally rectangular planar portion 52 and an arcuate portion 54 connected to one end of the planar portion 52. The arcuate portion 54 generally conforms in size and curvature to the arcuate portions 28, 30 on the top cap 12. A pull tab 56 extends upward from a lower end of the arcuate portion 54. A vertical wall 58 perpendicular to the pull tab 56 also extends upward from the lower end of the arcuate portion 54. A snap hook 60 extends generally horizontal from the bottom of the arcuate portion 54 in the direction of the planar portion 52 (albeit lower than the planar portion 52). A protrusion 62 extends upward from an end of the snap hook 60. A lower flange 64 extends downward from the snap hook 60 and the pull tab 56. The lower flange 64 is generally coplanar with the vertical wall 58.

The latch 14 includes a spring portion 66. The spring portion 66 includes a first leaf spring 68 and a second leaf spring 70. The spring portion 66 is connected to the planar portion 52 of the latch body 50 by a clasp or clasping portion 72. The clasping portion 72 includes a vertical wall 74 that extends downward from a mid-portion of the planar portion 52. A horizontal portion 76 extends from a bottom edge of the vertical wall 74. The horizontal portion 76 extends toward and connects to the spring portion 66. The horizontal portion 76 is parallel to the planar portion 52. A vertical wall 78 extends upwardly from the horizontal wall 76, bisecting the clasping portion 72 into two channels. The vertical wall 78 extends to an end of the spring portion 66 between the first and second leaf springs 68, 70.

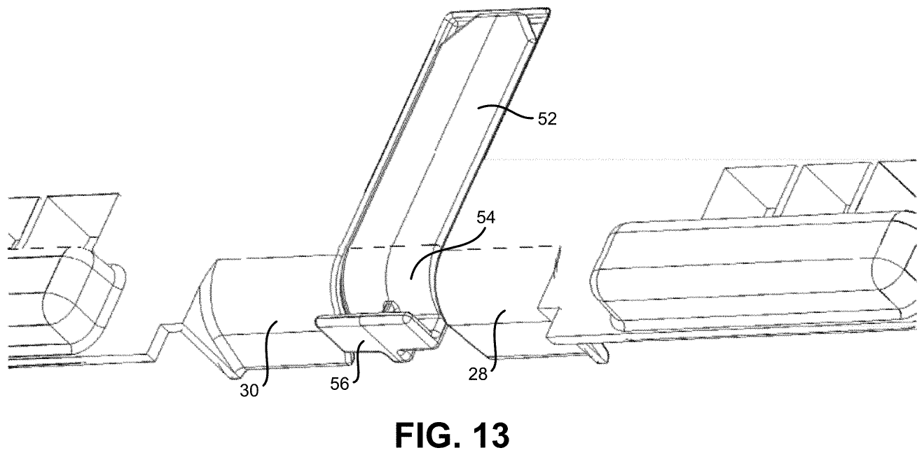

Referring to FIG. 13, when the latch 14 is connected to the top cap 12, the planar portion 52 and the arcuate portion 54 of the latch body 50 cover the slot 32. The pull tab 56 of the latch 14 extends outward beyond the arcuate portions 28, 30 in the top cap 12. However, as shown, the arcuate portions 28, 30 of the top cap 12 are positioned, or inset, slightly inward from the remainder of the end of the top cap 12 (i.e., the outermost edge) and the pull tab 56 does not extend outward beyond the remainder of the end of the top cap 12 when not in use.

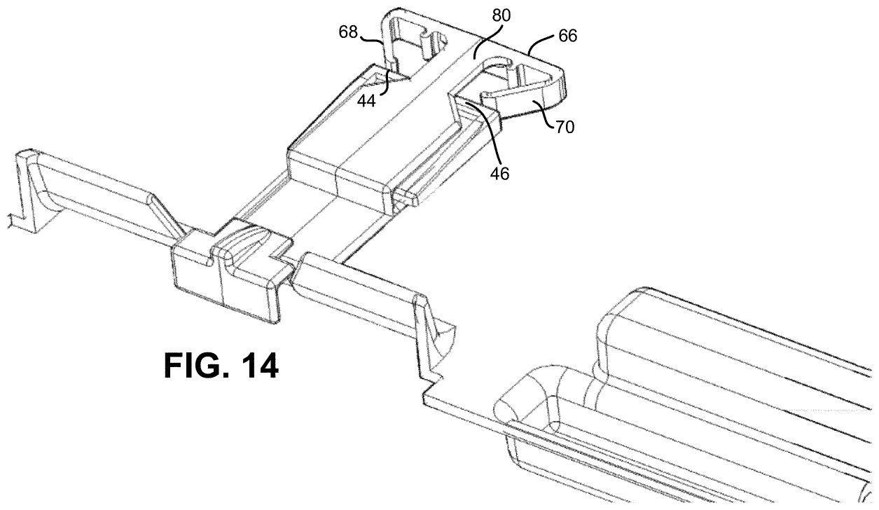

The latch 14 is shown secured to a lower surface of top cap 12 in FIG. 14. As illustrated, the first and second portions 36, 38 of the ramp 34 are sized to fit in the channels formed by the clasp 72 portion and vertical wall 78 of the latch 14. The spring portion 66 of the latch 14 extends through the gap 48 formed between the vertical walls 44, 46 of the ramp 34 by a bridge portion 80 connecting the spring portion 66 to the end of the horizontal wall 76 of the clasp portion 72. Each of the first and second leaf springs 68, 70 abuts the inner surface of a respective wall 44, 46. When the pull tab 56 is pulled forward to engage the container body 16, the arms of the leaf springs 68, 70 flex and compress against the vertical walls 44, 46 and provide a closing force on the snap hook 60. The compression of the leaf springs 68, 70 allows the snap hook 60 to move slightly forward and downward from its unused position.

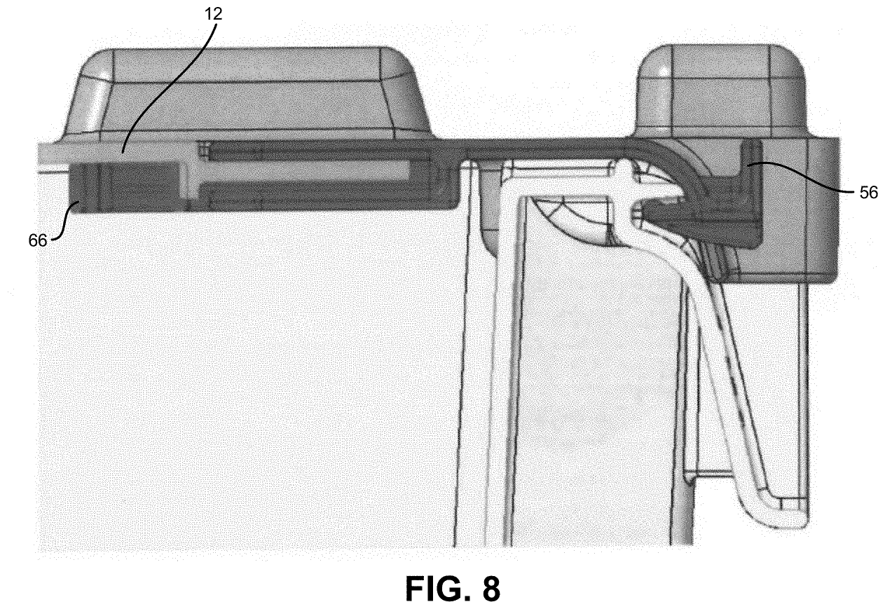

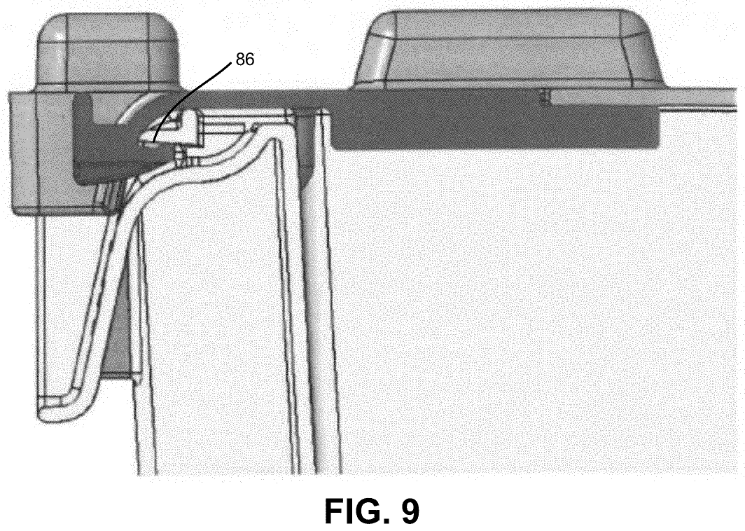

As illustrated in FIGS. 8 and 9, in operation the pull tab 56 of the latch 14 is pulled until the snap hook 60 engages and hooks onto structure in the container body 16. This compresses the leaf springs 68, 70 against the vertical walls 44, 46 of the ramp 34 which provides a force which secures the container body 16 to the top cap 12. The container body 16 can include a groove or tab 82 for receiving the snap hook 60. The groove or tab 82 could include structure that conforms to the shape of the protrusion 62 on the snap hook 60. The pull tab 56 can be pulled further down and/or outward to unlatch the top cap 12 from the container body 16.

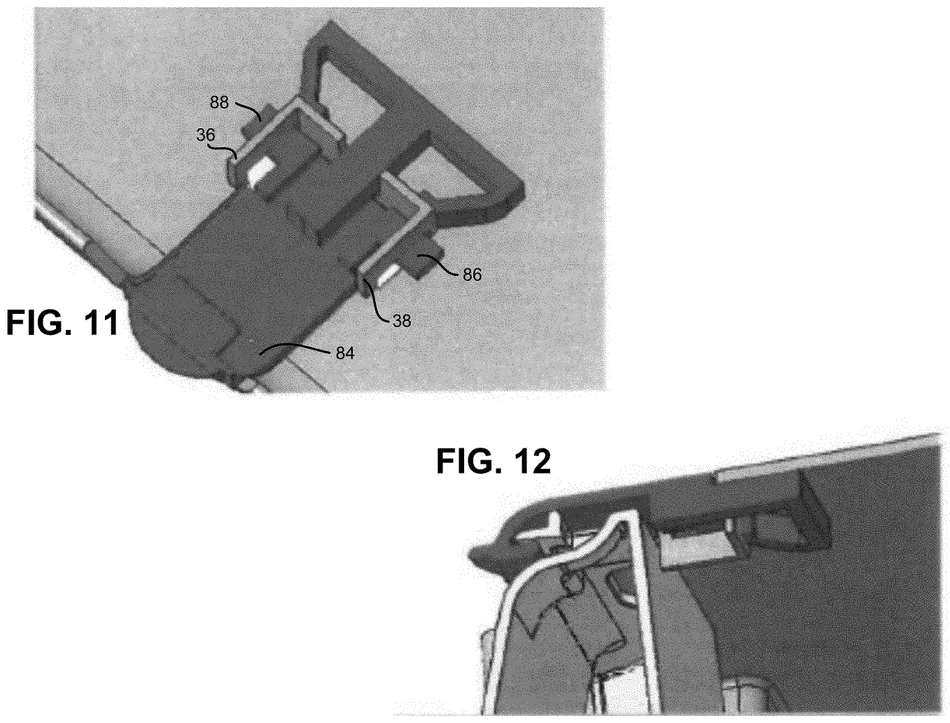

An alternative latch 84 is shown in FIGS. 11 and 12. The latch 84 includes first and second wings 86, 88 which extend from slots or openings in the first and second portions 36, 38 of the ramp 34. The wings 86, 88 help hold the latch 84 in place on the top cap 12.

Many modifications and variations of the present invention are possible in light of the above teachings. It is, therefore, to be understood within the scope of the appended claims the invention may be protected otherwise than as specifically described.

I claim:

1. A latch for connecting a top cap to a container body comprising:
a latch body;
a spring connected to the latch body and extending outward past a first end of the latch body; and,
a snap hook connected to the latch body and extending outward from a second end.

2. The latch of claim 1 wherein the latch body includes a first planar portion and a second arcuate portion.

3. The latch of claim 2 wherein the snap hook extends inward from an end of the arcuate portion.

4. The latch of claim 3 further comprising a pull tab extending from the arcuate portion.

5. The latch of claim 4 wherein the pull tab includes a vertical wall extending upward from a bottom portion of the arcuate portion.

6. The latch of claim 2 comprising a clasp portion extending downward from the first planar portion of the latch body.

7. The latch of claim 6 wherein the clasp portion includes a vertical wall connected at one end to a lower portion of the first planar portion.

8. The latch of claim 7 wherein the clasp portion includes a horizontal wall extending at a first end from a second end of the vertical wall.

9. The latch of claim 8 wherein the horizontal wall is parallel to the lower portion of the latch body.

10. The latch of claim 8 wherein the spring is connected to a second end of the horizontal wall of the clasp portion.

11. The latch of claim 7 wherein the vertical wall extends downward from a mid-portion of the planar portion of the latch body.

12. The latch of claim 10 wherein the spring includes a first leaf spring component.

13. The latch of claim 12 wherein the spring includes a second leaf spring component.

14. The latch of claim 13 wherein the latch is formed from plastic.

15. A latch assembly in a top cap for connecting the top cap to a container body comprising:
a top cap having a first side, a second side, a first end and a second end;
a first slot extending inward from the first end;
a first ramp extending from a bottom surface of the top cap connected proximate an interior end of the first slot;
a first latch having a clasp connected to the first ramp, a latch body, a spring and a snap hook configured to cooperate with a groove in the container body.

16. The latch assembly of claim 15 wherein the latch body includes a planar portion and an arcuate portion.

17. The latch assembly of claim 16 wherein the spring in the latch includes a first leaf spring element and a second leaf spring element.

18. The latch assembly of claim 17 wherein the ramp includes a vertical wall extending downward from the top cap.

19. The latch assembly of claim 18 wherein the first spring element and the second spring element are supported against the vertical wall of the ramp.

20. The latch assembly of claim 19 wherein the latch includes a pull tab.
